(19) United States
(12) Patent Application Publication
(10) Pub. No.: US 2022/0383368 A1
(43) Pub. Date: Dec. 1, 2022

(54) TRANSACTION TRACKING SYSTEM

(71) Applicant: The Title Girl, Inc., Addison, TX (US)

(72) Inventor: Chelsea Nicole Cunningham, Dallas, TX (US)

(73) Assignee: The Title Girl, Inc., Addison, TX (US)

(21) Appl. No.: 17/826,792

(22) Filed: May 27, 2022

Related U.S. Application Data
(60) Provisional application No. 63/194,766, filed on May 28, 2021.

(51) Int. Cl. G06Q 30/06; G06Q 20/32; G06Q 30/04

(52) U.S. Cl. CPC G06Q 30/0601; G06Q 20/3224; G06Q 30/04; G06Q 20/389

(57) ABSTRACT

A method implements a transaction tracking system. The method includes obtaining transaction information, obtaining county information, and calculating value information using the transaction information and the county information. The method further includes obtaining transfer information, comparing the transaction information to the transfer information to update status information, and presenting the status information.

### CROSS REFERENCE TO RELATED APPLICATIONS

This application claims the benefit of U.S. Provisional Application 63/194,766, filed May 28, 2021, which is herein incorporated by reference.

### BACKGROUND

Databases store records of transaction. A challenge is to identify and display transaction amounts that are not predicted.

### SUMMARY

In general, in one or more aspects, the disclosure relates to methods and systems that implement a transaction tracking system. The methods implemented by the systems include obtaining transaction information, obtaining county information, and calculating value information using the transaction information and the county information. The methods implemented by the systems further include obtaining transfer information, comparing the transaction information to the transfer information to update status information, and presenting the status information.

Other aspects of the invention will be apparent from the following description and the appended claims.

### BRIEF DESCRIPTION OF DRAWINGS

FIG. 1 shows a diagram of systems in accordance with disclosed embodiments.

FIG. 2 shows a flowchart in accordance with disclosed embodiments.

FIG. 3, FIG. 4A, FIG. 4B, FIG. 4C, FIG. 4D, FIG. 4E, FIG. 4F,

FIG. 4G, FIG. 4H, FIG. 5A, FIG. 5B, FIG. 5C, FIG. 5D, FIG. 5E, FIG. 5F, FIG. 5G, FIG. 5H, FIG. 5I, FIG. 5J, and FIG. 5K show examples in accordance with disclosed embodiments.

FIG. 6A and FIG. 6B show computing systems in accordance with disclosed embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure track transactions. For example, a transaction may be a vehicle sales transaction that involves transferring a title of the vehicle from a dealership to the purchaser of the vehicle. The transaction tracking system receives transaction information and monitors and tracks the status of the title transfer through to completion. The transaction tracking system also maintains a database of county title transfer information (referred to as a county database), which may include sales tax amounts, late fee amounts, late fee periods, etc.). The transaction tracking system calculates transfer fees using the county database. The transaction tracking system monitors financial accounts for the transfer information, which is compared to the transaction information.

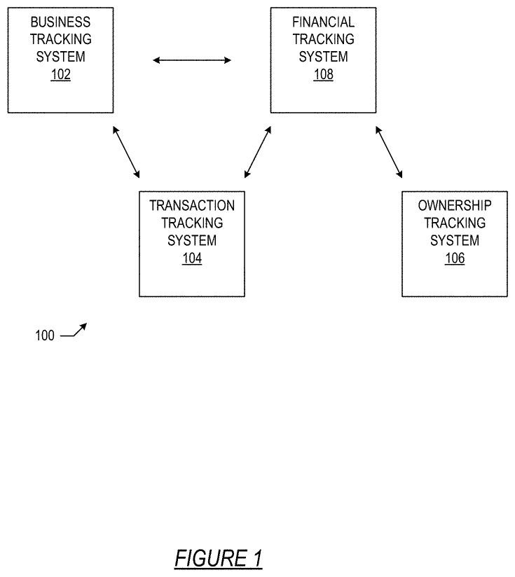

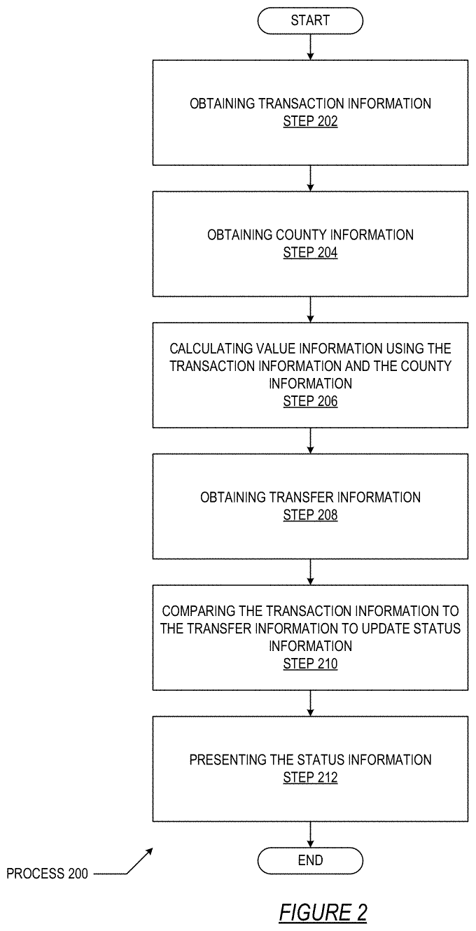

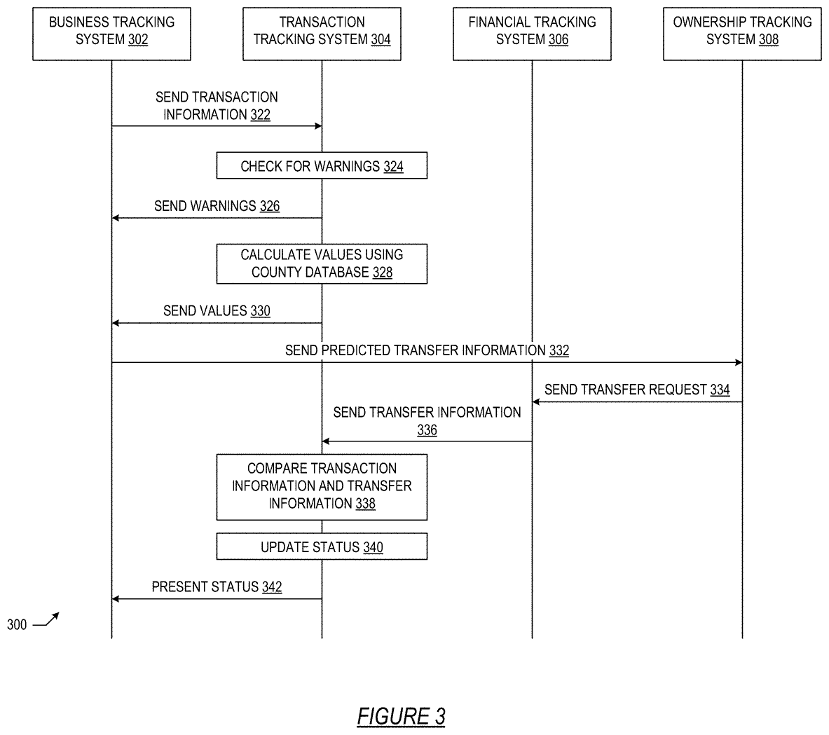

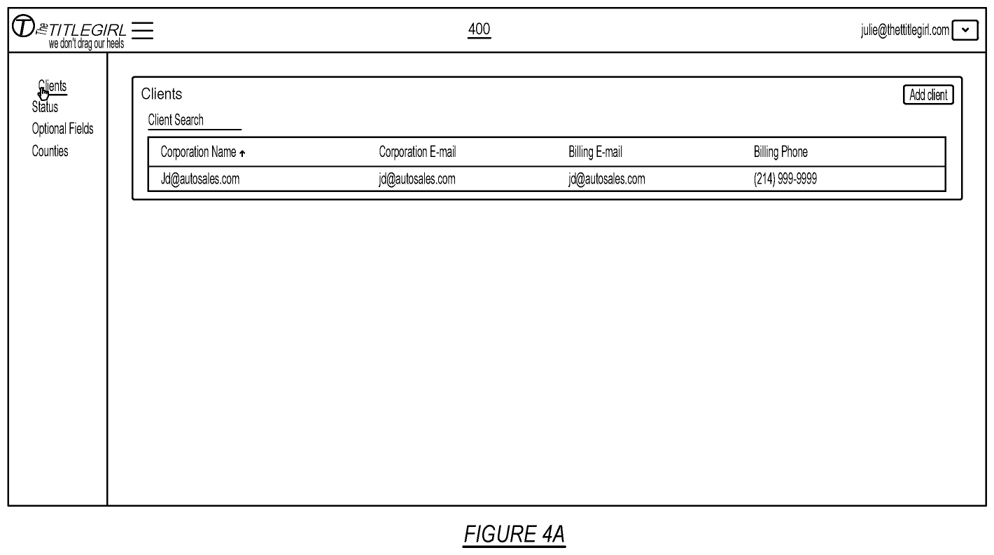

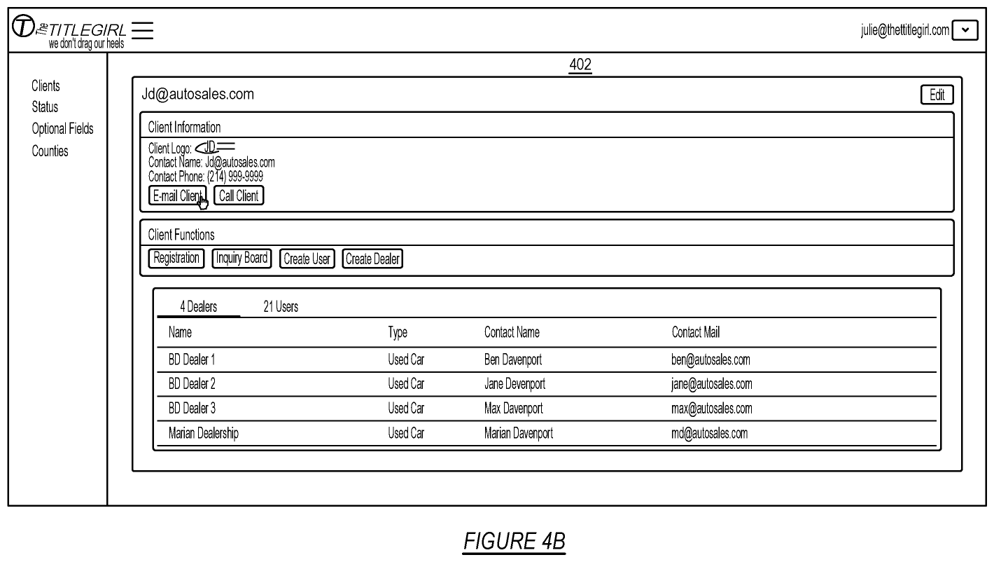

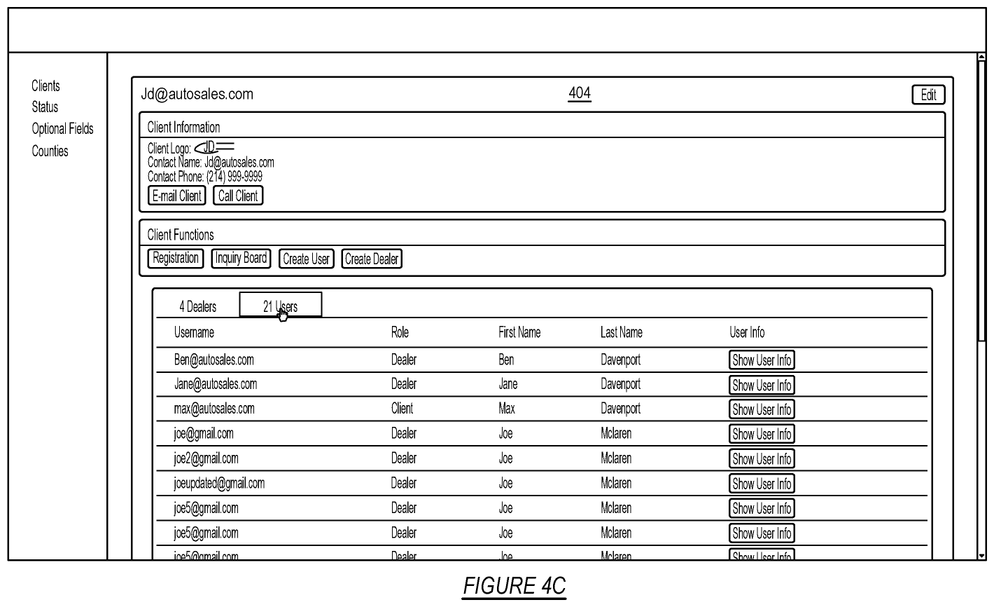

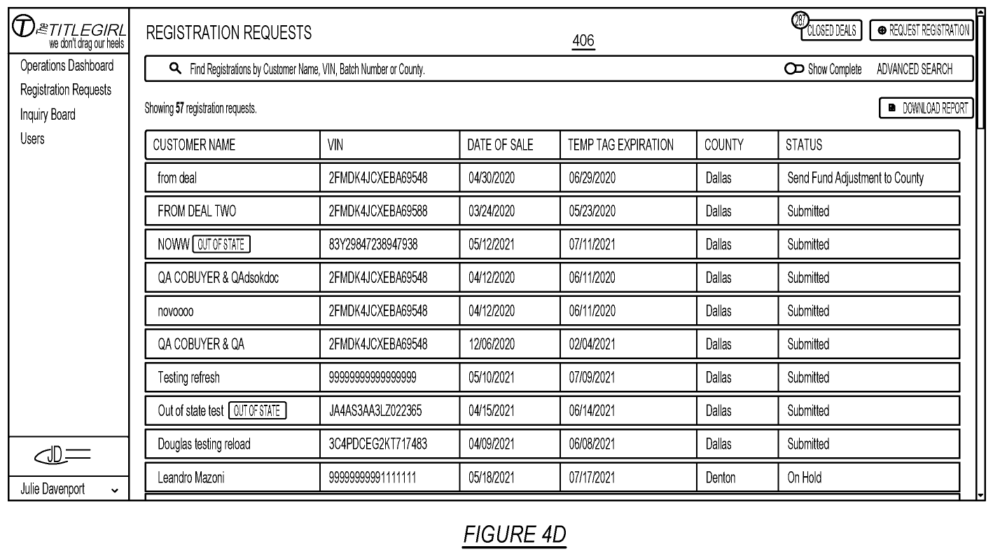

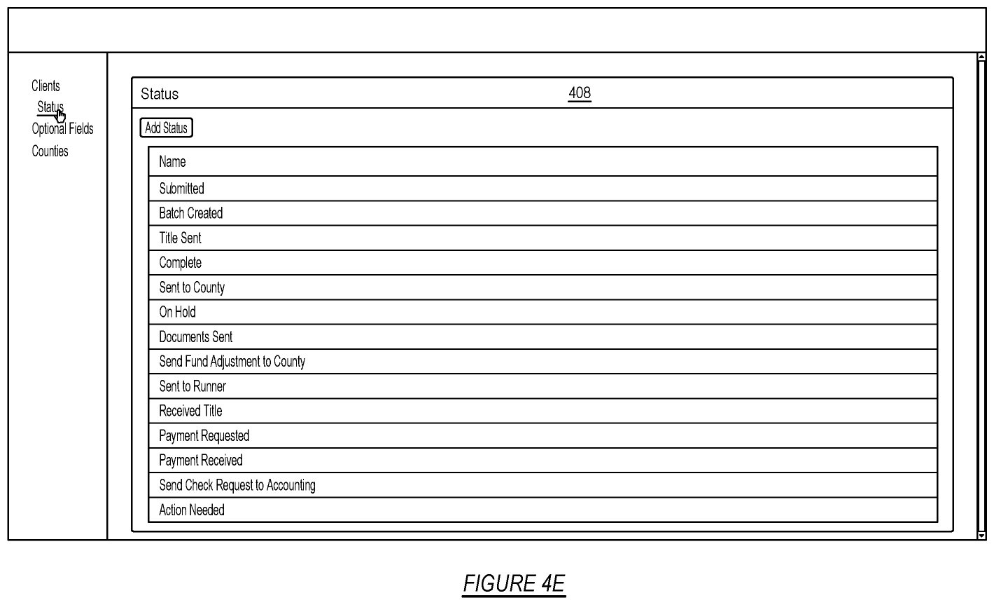

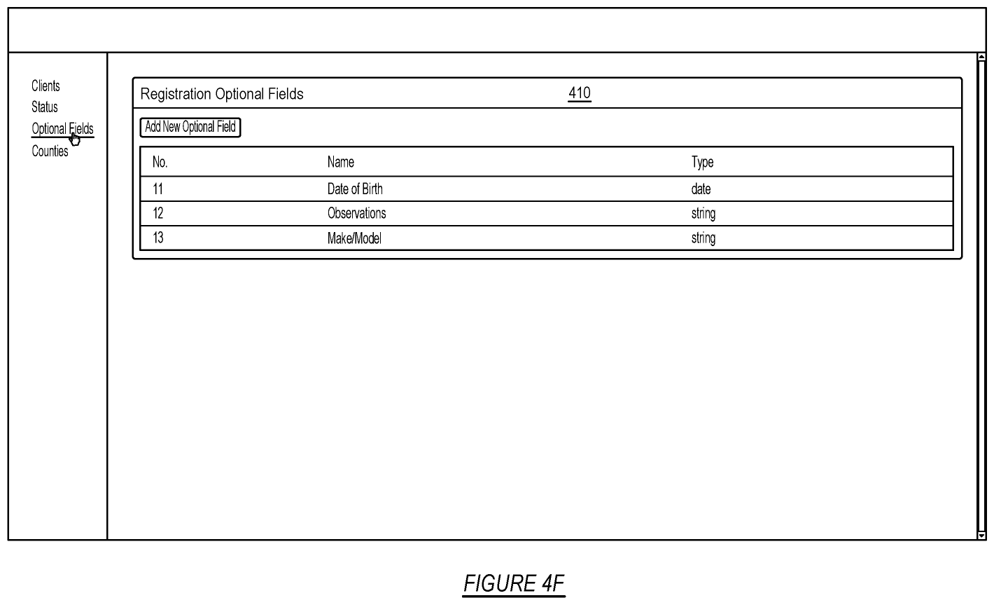

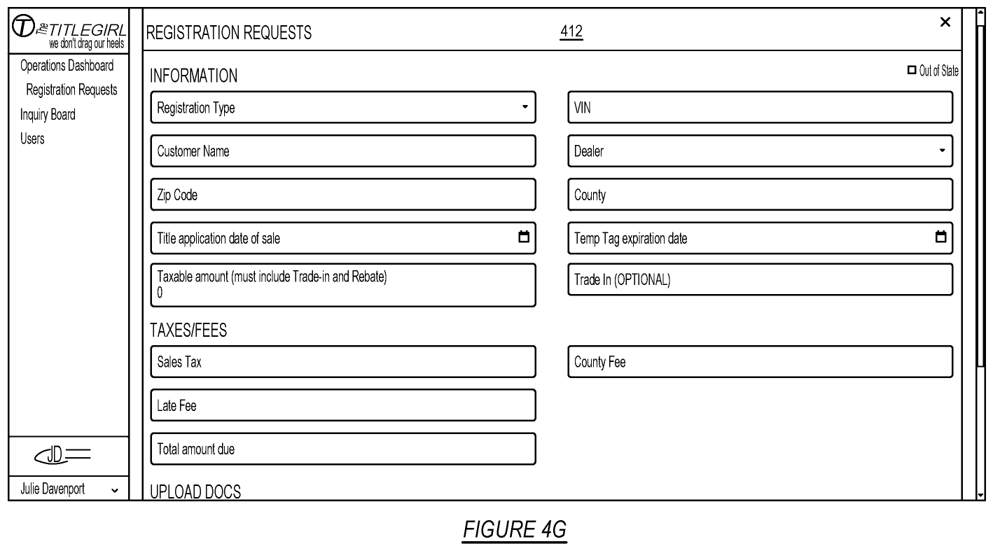

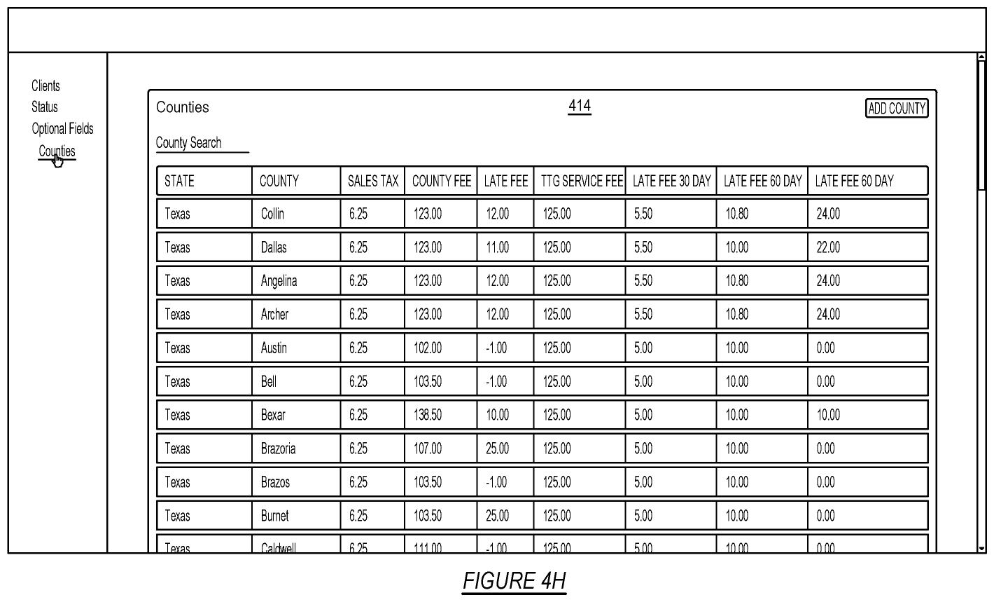

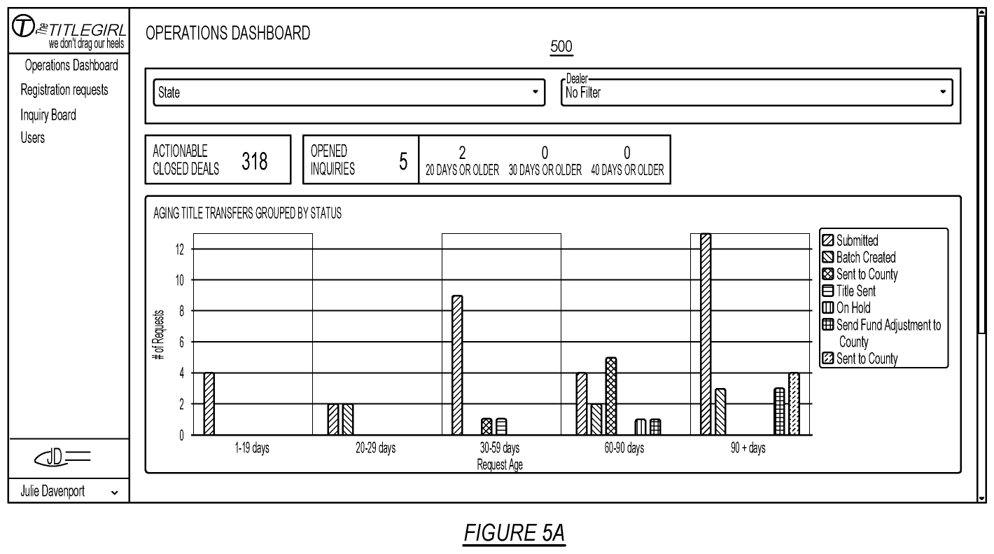

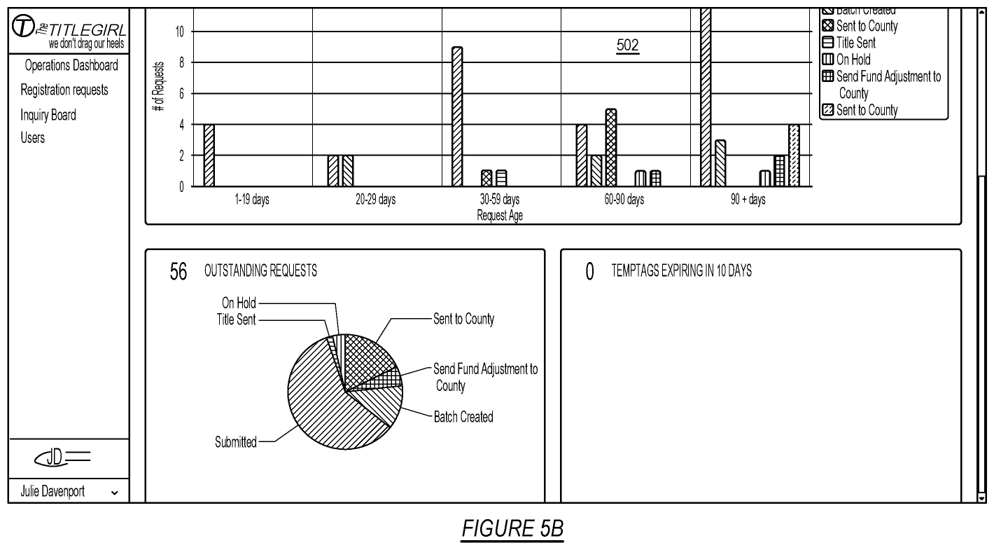

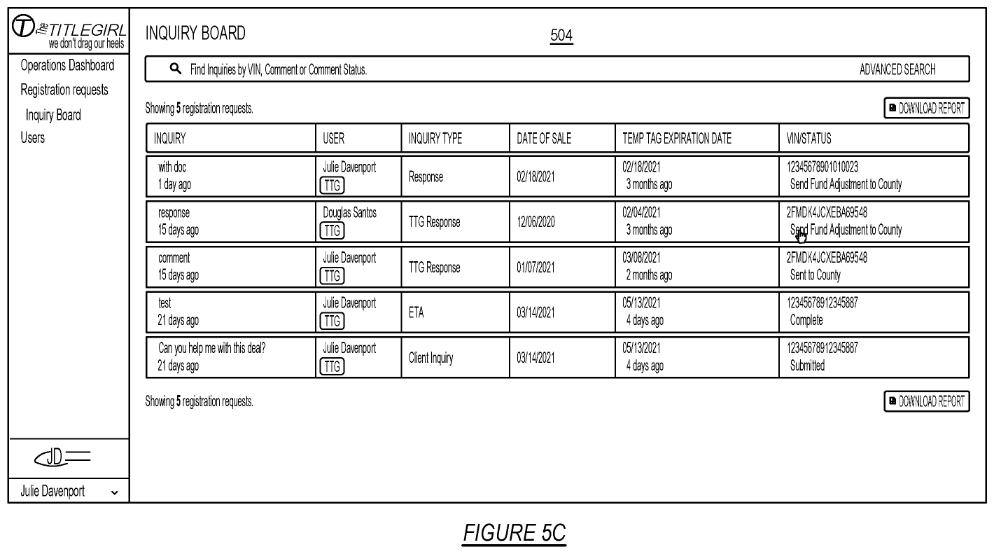

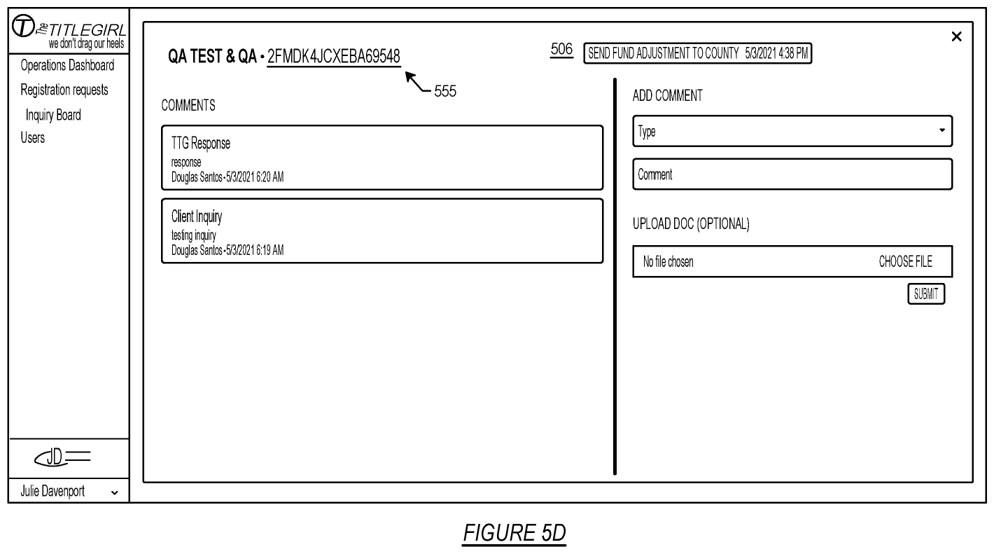

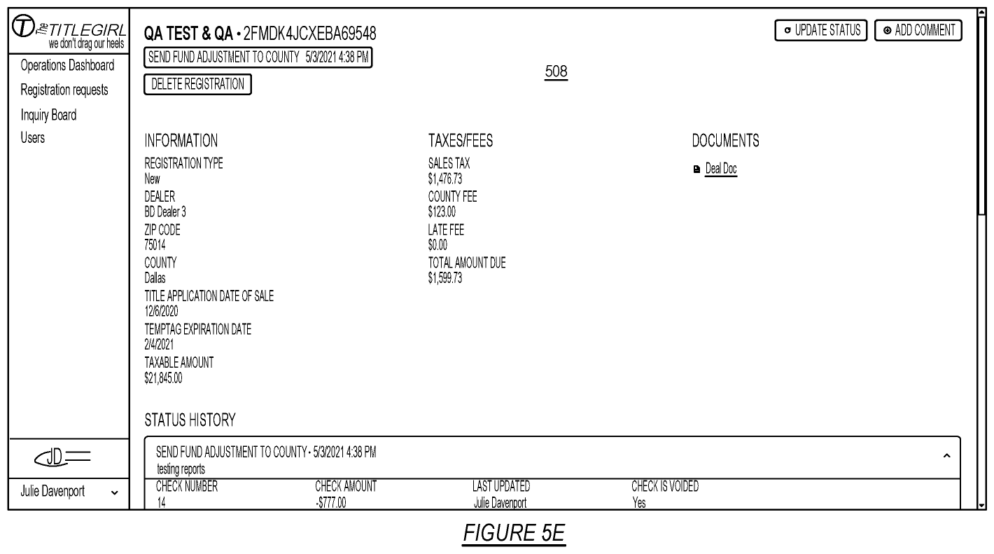

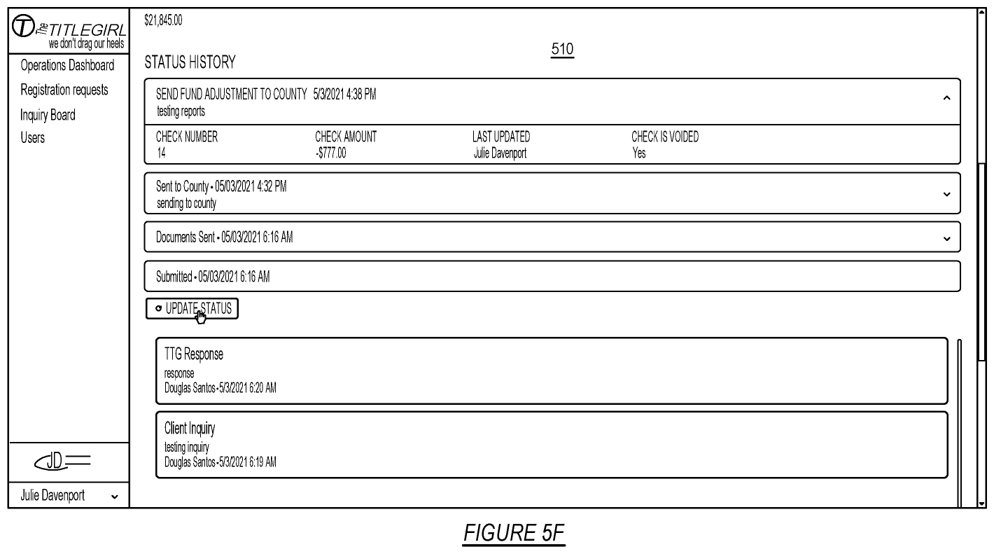

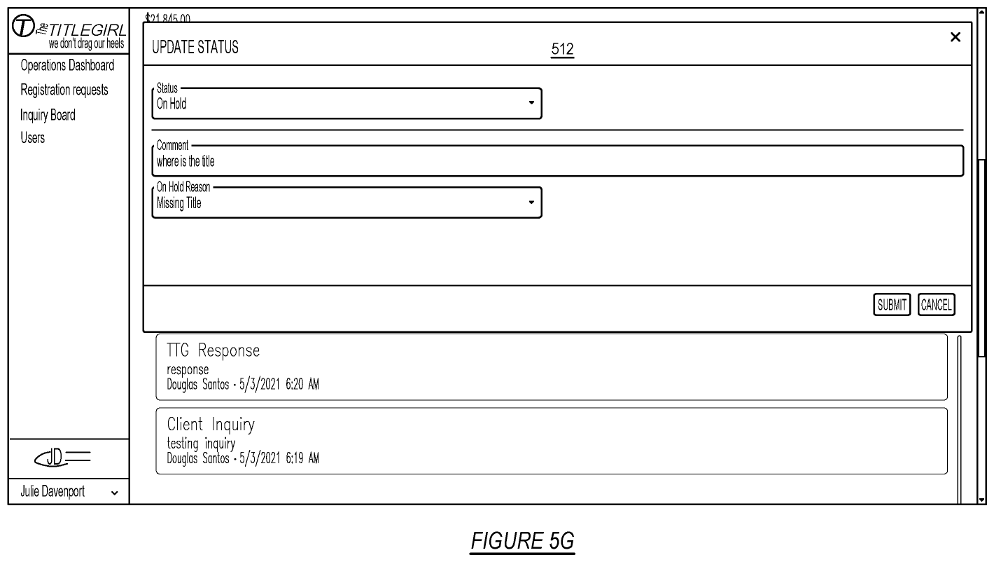

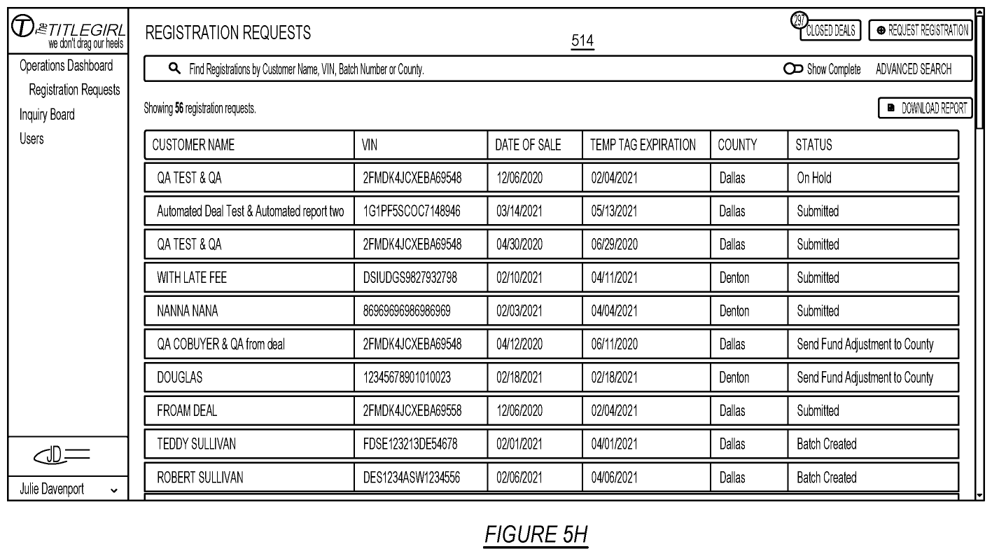

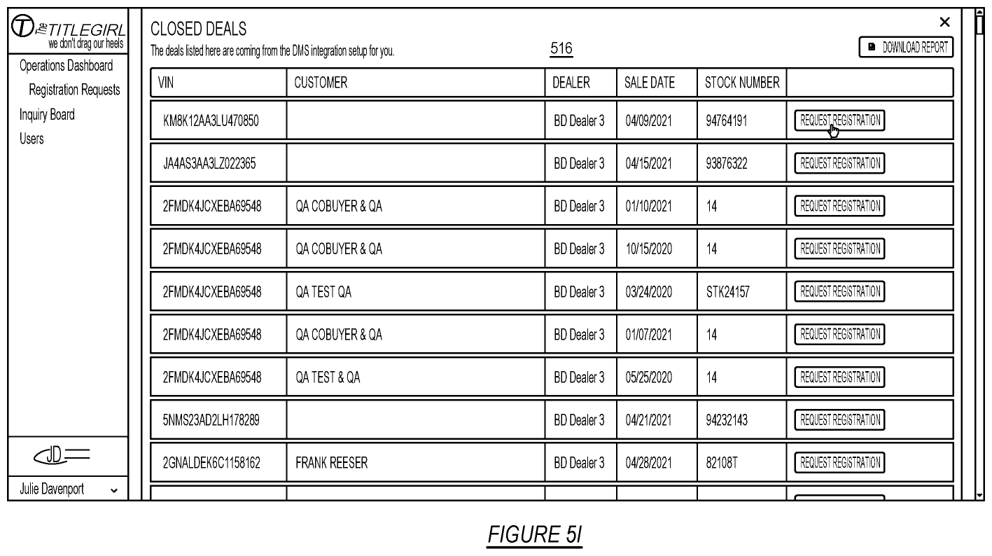

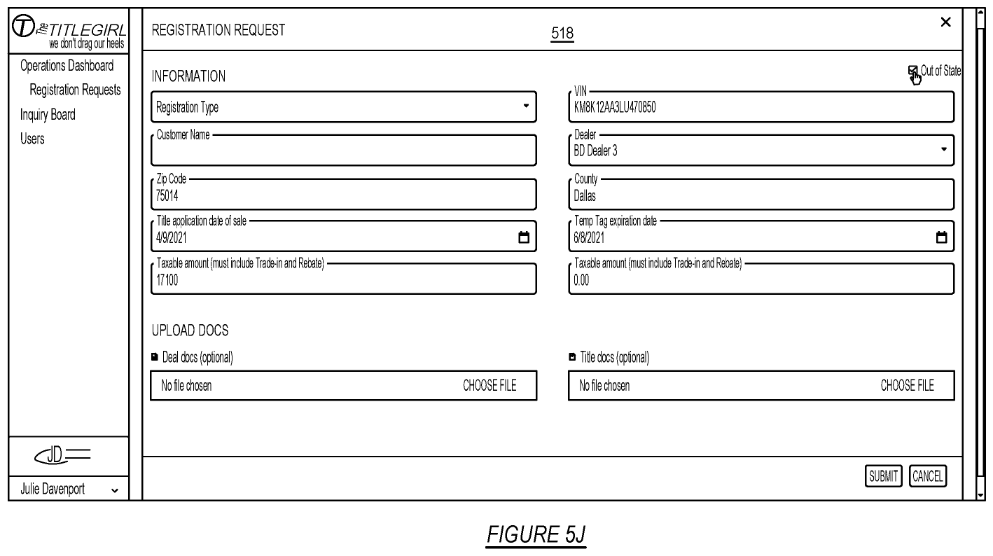

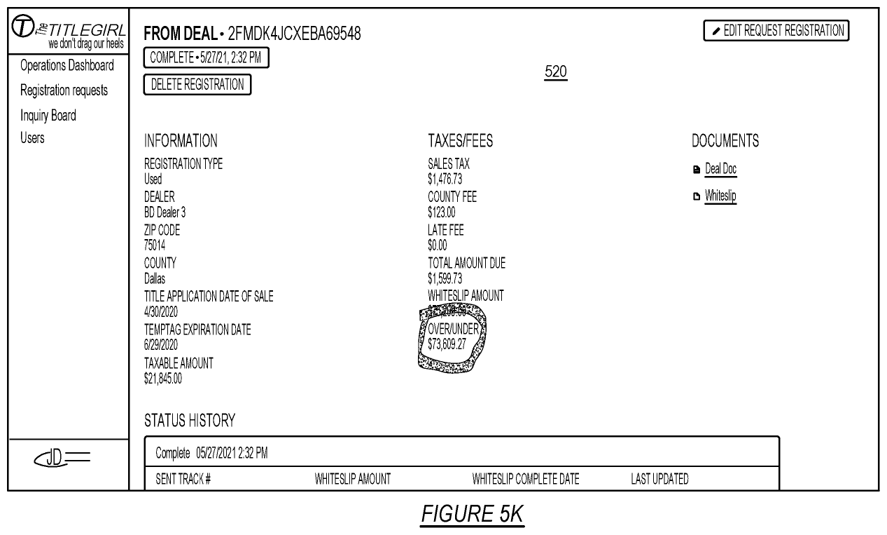

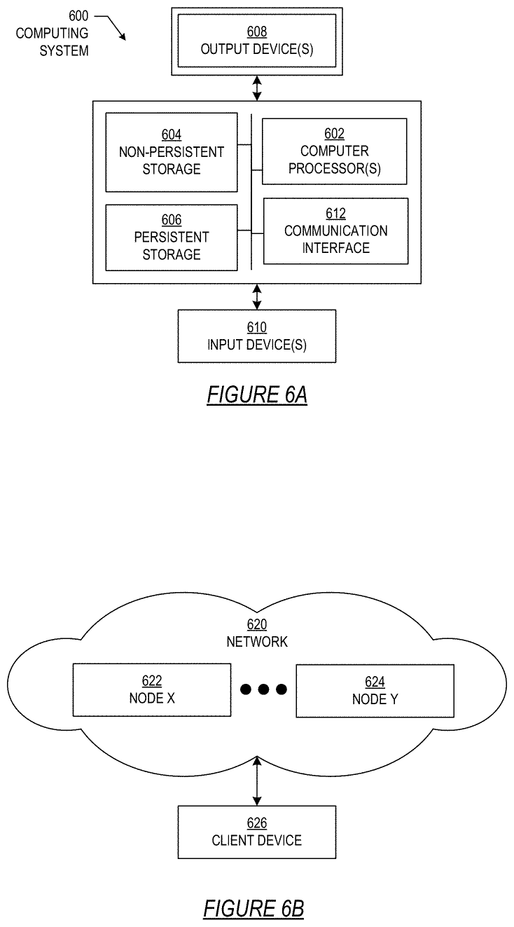

FIGS. 1, 2, 3, 4A through 4H, 5A through 5K, and 6A through 6B show embodiments that are in accordance with the disclosure. FIG. 1 shows the system (100) that tracks transactions. FIG. 2 shows a flowchart of the process (200) for tracking transactions. FIG. 3 shows a sequence diagram of the sequence (300) for tracking transactions. FIGS. 4A through 4H show graphical user interfaces administering a transaction tracking system. FIGS. 5A through 5K show graphical user interfaces using a transaction tracking system. FIGS. 6A and 6B show diagrams of a computing system in accordance with the disclosure. The embodiments of FIGS. 1, 2, 3, 4A through 4H, 5A through 5K, and 6A through 6B may be combined and may include or be included within the features and embodiments described in the other figures of the application. The features and elements of FIGS. 1, 2, 3, 4A through 4H, 5A through 5K, and 6A through 6B are, individually and as a combination, improvements to computing systems. The various elements, systems, and components shown in FIGS. 1, 2, 3, 4A through 4H, 5A through 5K, and 6A through 6B may be omitted, repeated, combined, and/or altered as shown in FIGS. 1, 2, 3, 4A through 4H, 5A through 5K, and 6A through 6B. Accordingly, the scope of the present disclosure should not be considered limited to the specific arrangements shown in FIGS. 1, 2, 3, 4A through 4H, 5A through 5K, and 6A through 6B.

Turning to FIG. 1, the system (100) monitors and tracks transactions. The system (100) includes the business tracking system (102), the transaction tracking system (104), the ownership tracking system (106), and the financial tracking system (108).

The business tracking system (102) is a set of hardware and software components that tracks the information of an entity. For example, the business tracking system (102) may be a dealer management system (DMS) that tracks the inventory of vehicles at a dealership as well as the accounting and financial records for the entity using the business tracking system (102). The business tracking system (102) may include server computers, personal computers, and corresponding software (including mobile applications, desktop applications, browser applications, etc.) as described in FIGS. 6A and 6B. The business tracking system (102) shares information with the other components and systems that make up the system (100) over a communications network.

The transaction tracking system (104) is a set of hardware and software components that tracks the transactions of the entity. For example, the transaction tracking system (104) may be a web service or host a website that maintains transaction information, compares the transaction information with transfer information, and reports information to users and the business tracking system (102). The transaction tracking system (104) may include server computers, personal computers, and corresponding software (including mobile applications, desktop applications, browser applications, etc.) as described in FIGS. 6A and 6B. The transaction tracking system (104) shares information with the other components and systems that make up the system (100) over a communications network.

The ownership tracking system (106) is a set of hardware and software components that tracks transfer information. For example, the ownership tracking system (106) may include the computing systems of a county government that tracks titles of vehicles in the county and charges fees to update the transfer information. The ownership tracking system (106) may include server computers, personal computers, and corresponding software (including mobile applications, desktop applications, browser applications, etc.) as described in FIGS. 6A and 6B. The ownership tracking system (106) shares information with the other components and systems that make up the system (100) over a communications network.

The financial tracking system (108) is a set of hardware and software components that tracks transfer information. For example, the financial tracking system (108) may include the computing systems of banks that track the values of accounts for the entity operating the business tracking system (102) and the county of the ownership tracking system (106). The financial tracking system (108) may include server computers, personal computers, and corresponding software (including mobile applications, desktop applications, browser applications, etc.) as described in FIGS. 6A and 6B. The financial tracking system (108) shares information with the other components and systems that make up the system (100) over a communications network.

Turning to FIG. 2, the process (200) tracks transactions. The process (200) may operate on a server of a transaction tracking system.

At Step 202, transaction information is obtained. In one embodiment, the transaction information may be for the sale of a vehicle at a dealership. The transaction information includes data identifying the date of the transaction, the amount of the transaction, the customer purchasing the vehicle, the county in which the transaction occurred, the dealer selling the vehicle, etc.

At Step 204, county information is obtained. In one embodiment, the county information includes data identifying sales tax, periods for late fees, late fees, etc.

At Step 206, value information is calculated using the transaction information and the county information. In one embodiment, the system calculates late fees that are due for the transaction by extracting sales information from the transaction information, identifying the county of the transaction from the transaction information, extracting late fee information from the county information, and applying the late fee information to the sales information.

At Step 208, transfer information is obtained. In one embodiment, the transfer information is obtained by connecting to a financial tracking system (e.g., a website of a bank) and scraping transfer information for the dealer identified in the transaction information.

At Step 210, the transaction information is compared to the transfer information to update status information. In one embodiment, the sales amount from the transaction information is matched to a transfer amount from the transfer information to identify that transaction fees have been paid for the transaction identified by the transaction information. The status information may be updated to indicate that the transaction is complete.

A Step 212, the status information is presented. In one embodiment, the status information may be transmitted from a server of the transaction tracking system to a client device that displays this status information to a user of the system.

Turning to FIG. 3, the sequence (300) tracks transactions. The sequence (300) is performed by the business tracking system (302), the transaction tracking system (304), the financial tracking system (306), and the ownership tracking system (308). Each of the systems (302), (304), (306), and (308) may include servers and client devices that transmit messages between the different systems. In one embodiment, the messages are transmitted using network and file standards and protocols, including, internet protocol (IP), hypertext transmission protocol secure (HTTPS), hypertext markup language (HTML), JavaScript Object Notation (JSON), etc.

At Step 322, transaction information is sent from the business tracking system (302) to the transaction tracking system (304). In one embodiment, the transaction information includes information about the sale of a vehicle to a customer at a dealership.

At Step 324, the transaction tracking system (304) checks for warnings. In one embodiment, the warnings may be checked periodically (weekly, monthly, etc.) by the transaction tracking system (304) for each of the transactions being tracked with the transaction tracking system (304). The transaction tracking system (304) may generate a warning when a period of time is about to expire that would trigger a late fee. For example, a late fee may be incurred after 30 days and the warning may be generated on the 20th day, which is 10 days before the late fee would be incurred.

At Step 326, warnings are sent from the transaction tracking system (304) to the business tracking system (302). The warnings indicate that a late fee may be about to be triggered and may identify the late fee and the date the late fee will be incurred.

At Step 328, values are calculated using a county database. In one embodiment, the transaction tracking system (304) maintains a county database that is continuously updated with county information that identifies sales tax amounts, late fee amounts, late fee periods, etc. In one embodiment, the transaction tracking system (304) applies the county information to the transaction information to generate predicted transfer information that identifies a predicted value for the amount of sales tax and late fees that are due for a transaction identified by the transaction information.

At Step 330 the predicted transfer information (332) is received by the ownership tracking system (308). In one embodiment, the ownership tracking system (308) is a computing system operated by a government entity (e.g., a county government). In one embodiment, the predicted transfer information may be sent electronically. In one embodiment, a user of the ownership tracking system may input the predicted transfer information to the ownership tracking system (308).

At Step 334, the financial tracking system (306) receives a transfer request from the ownership tracking system (308). In one embodiment, the transfer request identifies a bank account of the dealer from the transaction information and an amount to transfer from the bank account of the dealer to a bank account of the government entity that operates the ownership tracking system (308).

At Step 336, transfer information is received by the transaction tracking system (304). In one embodiment, the transaction tracking system (304) scrapes the transfer information from the financial tracking system (306).

At Step 338, the transaction tracking system (304) compares the transaction information and the transfer information. The comparison may identify a match between the amount from the predictive transfer information with an amount from the transfer information, which may indicate that the sales tax for the vehicle purchase has been paid.

At Step 340, the transaction tracking system (304) updates the status. After matching values between the predicted transfer information and the transfer information, the transaction tracking system (304) may update the transaction information to indicate that the transaction is complete.

At Step 342, the transaction tracking system (304) presents the status. In one embodiment, the status is presented by sending a message from the transaction tracking system (304) to a client device of the business tracking system (302). The message includes the status and may be displayed by the client device.

FIGS. 4A through 4H, show the interfaces (400) through (414), which are graphical user interfaces. The interfaces (400) through (414) are used to administer a transaction tracking system.

Turning to FIG. 4A, the interface (400) shows a “clients” screen. The “clients” screen shows a client of the transaction tracking system.

Turning to FIG. 4B, the interface (402) shows additional information of the client. The additional information includes information about four (4) dealers and twenty one (21) users of the client.

Turning to FIG. 4C, the interface (404) shows additional information of the client. The additional information includes information about twenty-one (21) users of the client.

Turning to FIG. 4D, the interface (406) shows a “registration requests” screen. The “registration requests” screen is shown after clicking on the “registration requests” widget on the left sidebar. The “registration requests” screen shows requests about the status of the registration for a number of vehicle purchase transactions.

Turning to FIG. 4E, the interface (408) shows a “status” screen. The status screen identifies the options for the status of a vehicle transaction.

Turning to FIG. 4F, the interface (410) shows a “registration optional fields” screen. The “registration optional fields” screen includes widgets to add optional fields to transactions.

Turning to FIG. 4G, the interface (412) shows a “registration request” screen. The “registration request” screen includes fields of information that may be entered for a transaction that is tracked with the transaction tracking system.

Turning to FIG. 4H, the interface (414) shows a “counties” screen. The “counties” screen shows information from county databases with information about the sales tax amounts, late fees, and late fee periods for different counties.

FIGS. 5A through 5K, show the interfaces (500) through (520), which are graphical user interfaces. The interfaces (500) through (518) are used to interact with the transaction tracking system.

Turning to FIG. 5A, the interface (500) shows an “operations dashboard” screen. The “operations dashboard” screen presents a report with bar graphs for the late status of transactions tracked by the system.

Turning to FIG. 5B, the interface (502) shows more of the “operations dashboard” screen. Additional widgets are shown to report information from the transaction tracking system.

Turning to FIG. 5C, the interface (504) shows an “inquiry board” screen. The “inquiry board” screen displays a summary of inquiries about the status of a list of transactions.

Turning to FIG. 5D, the interface (506) shows a “comments” screen. The “comments” screen is used to add comments on the status of a transaction.

Turning to FIG. 5E, the interface (508) shows a “status” screen. The “status” screen shows transaction information that includes late fee information for a transaction.

Turning to FIG. 5F, the interface (510) shows more of the “status” screen. The additional information includes a status history for the transaction.

Turning to FIG. 5G, the interface (512) shows an “update status” screen. The “update status” screen is displayed after selection of the “update status” button from the interface (510). The “update status” screen is used to set the status of the transaction.

Turning to FIG. 5H, the interface (514) shows a “registrations request” screen. The “registrations request” screen is displayed after selecting the “registrations request” widget from the left sidebar. The “registrations request” screen shows a list of registration requests.

Turning to FIG. 5I, the interface (516) shows a “closed deals” screen. The “closed deals” screen is displayed after selecting the “closed deals” button from the interface (514). The “closed deals” screen shows a list of transactions (i.e., “deals”) that have closed (e.g., the vehicle was purchased) but which have not been completed (e.g., the sales tax has not been transferred).

Turning to FIG. 5J, the interface (518) shows a “registration request” screen. The “registration request” screen is used to enter information about the transaction to track the transaction.

Turning to FIG. 5K, the interface (520) shows the “status” screen after the transaction is complete. The interface (520) is updated from the interface (508) to include the “whiteslip amount” field and the “over/under” field. The “whiteslip amount” field identifies the value transferred to the ownership tracking system and the “over/under” field identifies the differences between a predicted value and the value from the “whiteslip amount” field. In one embodiment, the whiteslip amount corresponds to the amount paid to a tax entity (e.g., a county government), which includes sales tax and late fees, and the over/under amount is the difference between the whiteslip amount and the predicted payment amount (e.g., the predicted sales tax and late fees).

Embodiments of the invention may be implemented on a computing system. Any combination of a mobile, a desktop, a server, a router, a switch, an embedded device, or other types of hardware may be used. For example, as shown in FIG. 6A, the computing system (600) may include one or more computer processor(s) (602), non-persistent storage (604) (e.g., volatile memory, such as a random access memory (RAM), cache memory), persistent storage (606) (e.g., a hard disk, an optical drive such as a compact disk (CD) drive or a digital versatile disk (DVD) drive, a flash memory, etc.), a communication interface (612) (e.g., Bluetooth interface, infrared interface, network interface, optical interface, etc.), and numerous other elements and functionalities.

The computer processor(s) (602) may be an integrated circuit for processing instructions. For example, the computer processor(s) (602) may be one or more cores or micro-cores of a processor. The computing system (600) may also include one or more input device(s) (610), such as a touchscreen, a keyboard, a mouse, a microphone, a touchpad, an electronic pen, or any other type of input device.

The communication interface (612) may include an integrated circuit for connecting the computing system (600) to a network (not shown) (e.g., a local area network (LAN), a wide area network (WAN) such as the Internet, a mobile network, or any other type of network) and/or to another device, such as another computing device.

Further, the computing system (600) may include one or more output device(s) (608), such as a screen (e.g., a liquid crystal display (LCD), a plasma display, a touchscreen, a cathode ray tube (CRT) monitor, a projector, or other display device), a printer, an external storage, or any other output device. One or more of the output device(s) (608) may be the same or different from the input device(s) (610). The input and output device(s) (610 and (608)) may be locally or remotely connected to the computer processor(s) (602), non-persistent storage (604), and persistent storage (606). Many different types of computing systems exist, and the aforementioned input and output device(s) (610 and (608)) may take other forms.

Software instructions in the form of computer readable program code to perform embodiments of the invention may be stored, in whole or in part, temporarily or permanently, on a non-transitory computer readable medium such as a CD, a DVD, a storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (600) in FIG. 6A may be connected to or be a part of a network. For example, as shown in FIG. 6B, the network (620) may include multiple nodes (e.g., node X (622), node Y (624)). Each node may correspond to a computing system, such as the computing system (600) shown in FIG. 6A, or a group of nodes combined may correspond to the computing system (600) shown in FIG. 6A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (600) may be located at a remote location and connected to the other elements over a network.

Although not shown in FIG. 6B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (622), node Y (624)) in the network (620) may be configured to provide services for a client device (626). For example, the nodes may be part of a cloud computing system. The nodes may include functionality to receive requests from the client device (626) and transmit responses to the client device (626). The client device (626) may be a computing system, such as the computing system (600) shown in FIG. 6A. Further, the client device (626) may include and/or perform all or a portion of one or more embodiments of the invention.

The computing system (600) or group of computing systems described in FIGS. 6A and 6B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding a particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system (600) in FIG. 6A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system (600) of FIG. 6A, while performing one or more embodiments of the invention, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system (600) in FIG. 6A may implement and/or be connected to a data repository. For example, one type of data repository is a database. A database is a collection of information configured for ease of data retrieval, modification, re-organization, and deletion. A Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g., join, full join, count, average, etc.), sort (e.g., ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system (600) of FIG. 6A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system (600) of FIG. 6A and the nodes (e.g., node X (622), node Y (624)) and/or client device (626) in FIG. 6B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
obtaining transaction information;
obtaining county information;
calculating value information using the transaction information and the county information;
obtaining transfer information;
comparing the transaction information to the transfer information to update status information; and
presenting the status information.

2. The method of claim 1, further comprising:
obtaining, by a transaction tracking system from a business tracking system, the transaction information, wherein the transaction information is stored as data that includes data identifying a date of the transaction, an amount of the transaction, a customer purchasing a vehicle, a county in which the transaction occurred, and a dealer selling the vehicle.

3. The method of claim 1, further comprising:
checking a period of time of a transaction described by the transaction information;
generating a waning before the period of time has expired; and
transmitting, by a transacting tracking system, the warning to a business tracking system.

4. The method of claim 1, further comprising:
maintaining the county information in a county database, wherein the county information identifies a sales tax amount, a late fee amount, and a late fee period.

5. The method of claim 1, further comprising:
generating predicted transfer information that identifies predicted values of an amount of sales tax and a late fee of a transaction identified by the transaction information.

6. The method of claim 1, further comprising:
scraping, by a transaction tracking system, the transfer information from a financial tracking system.

7. The method of claim 1, further comprising:
comparing the transaction information to the transfer information by comparing an amount from predicted transaction information with an amount from the transfer information.

8. The method of claim 1, further comprising:
presenting a total amount field comprising a value from predicted transaction information.

9. The method of claim 1, further comprising:
presenting a whiteslip amount field comprising a value from the transfer information.

10. The method of claim 1, further comprising:
presenting an over-under field comprising a difference between a total amount field and a whiteslip amount field.

11. A system comprising:
a transaction tracking system in communication with a business tracking system and a financial tracking system;
an application executing on one or more processors of the transaction tracking system and configured for:
obtaining, by the transaction tracking system, transaction information from the business tracking system;
obtaining, by the transaction tracking system, county information;
calculating, by the transaction tracking system, value information using the transaction information and the county information;
obtaining, by the transaction tracking system, transfer information from the financial tracking system;
comparing, by the transaction tracking system, the transaction information to the transfer information to update status information; and
presenting the status information.

12. The system of claim 11, wherein the application is further configured for:
obtaining, by a transaction tracking system from the business tracking system, the transaction information, wherein the transaction information is stored as data that includes data identifying a date of the transaction, an amount of the transaction, a customer purchasing a vehicle, a county in which the transaction occurred, and a dealer selling the vehicle.

13. The system of claim 11, wherein the application is further configured for:
checking a period of time of a transaction described by the transaction information;
generating a waning before the period of time has expired; and
transmitting, by a transacting tracking system, the warning to the business tracking system.

14. The system of claim 11, wherein the application is further configured for:
maintaining the county information in a county database, wherein the county information identifies a sales tax amount, a late fee amount, and a late fee period.

15. The system of claim 11, wherein the application is further configured for:
generating predicted transfer information that identifies predicted values of an amount of sales tax and a late fee of a transaction identified by the transaction information.

16. The system of claim 11, wherein the application is further configured for:
scraping, by a transaction tracking system, the transfer information from the financial tracking system.

17. The system of claim 11, wherein the application is further configured for:
comparing the transaction information to the transfer information by comparing an amount from predicted transaction information with an amount from the transfer information.

18. The system of claim 11, wherein the application is further configured for:
presenting a total amount field comprising a value from predicted transaction information.

19. The system of claim 11, wherein the application is further configured for:
presenting a whiteslip amount field comprising a value from the transfer information; and
presenting an over-under field comprising a difference between a total amount field and the whiteslip amount field.

20. A method comprising:
transmitting a request;
displaying an over-under field comprising a difference between a total amount field calculated using transaction information and the whiteslip amount field from transfer information, wherein the over-under field is generated by:
obtaining the transaction information;
obtaining county information;
calculating value information using the transaction information and the county information;
obtaining transfer information; and
comparing the transaction information to the transfer information to generate the over-under field.
